(19) United States
(12) Patent Application Publication
(10) Pub. No.: US 2010/0049543 A1
(43) Pub. Date: Feb. 25, 2010

(54) Health data integration system and the method thereof

(75) Inventors: Chaucer Chiu, Taipei (TW); Frances Dai, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/230,057

(22) Filed: Aug. 22, 2008

(51) Int. Cl. G06Q 50/00

(52) U.S. Cl. 705/3

(57) ABSTRACT

A health data integration system and the method thereof for solving the problems of inconvenience in recording health data and limited applications are provided. The detected health data are transmitted via a network to a server for recording and analysis. Afterwards, a health advice is generated as a reference for health consulting. The present system facilitates convenience in recording health data and the uses thereof.

### BACKGROUND OF THE INVENTION

1. Field of Invention

The invention relates to a data integration system and the method thereof. In particular, the invention relates to a system of recording and analyzing the detected health data via a network and the method thereof.

2. Related Art

In recent years, along with the rapid development in semiconductor technology and the increase in health consciousness, many sensors for detecting personal body/medical data (i.e., health data) have been invented. Examples are pedometers, blood pressure meters, body fat monitors. They not only allow users to conveniently know of personal health conditions, but also serve as important references for exercising and diet control.

Generally speaking, the above-mentioned sensors produce health data according to the detected results. However, such health data have to be recorded and tracked by the user. They do not provide further processing or applications based on the produced health data, such as providing the user with appropriate exercise/medical advice. In other words, they have the problems of inconvenience in recording health data and limited applications.

For these, some vendors provide built-in storage space in the sensors for the user to save the detected health data therein by clicking some functional keys. Nevertheless, the capacity of the storage space is still limited for practical uses. Besides, they still cannot perform analyses or have applications according to the detected health data in order to increase the additional values thereof. Therefore, the same problems are not solved even after installing built-in storage space in the sensors.

In summary, the prior long has the problems of inconvenience in recording health data and limited applications. It is thus imperative to provide a solution.

### SUMMARY OF THE INVENTION

In view of the foregoing, the invention discloses a health data integration system and the method thereof.

The disclosed health data integration system includes: an information receiving module, a data receiving module, a health database, a report generating module, a transmitting module, and a consulting module. The information receiving module receives consulting messages. The data receiving module receives health data transmitted from the client. The health database stores health data and analysis conditions. The reporting generating module generates a health advice report according to the health data and analysis conditions. The transmitting module transmits the health advice report to the client. The consulting module transmits the consulting messages and health advice report to a network community.

The disclosed health data integration method includes the steps of: establishing analysis conditions in a health database; receiving and storing the heath data transmitted from a client to the health database; generating a health advice report according to the health data and analysis conditions; transmitting the health advice report to the client; receiving consulting messages and transmitting the consulting messages and health advice report to a network community.

According to the system and method described above, the invention is different from the prior art in that it transmits the detected health data to a server for recording and analysis via a network. Afterwards, a health advice report is generated as a reference of health consulting.

Through the disclosed techniques, the present invention can enhance the convenience in recording health data and increase the applications thereof.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed health data integration system;

FIG. 2 is a flowchart of the disclosed health data integration method;

FIG. 3 is a schematic view showing the operation of entering the health data according to the invention;

FIG. 4 is a schematic view of health consulting according to the invention;

FIG. 5 is a schematic view showing the operation of an online diagnosis according to the invention; and

FIG. 6 is a schematic view of the statistical charts used in the invention.

### DETAILED DESCRIPTION OF THE INVENTION

The present invention will be apparent from the following detailed description, which proceeds with reference to the accompanying drawings, wherein the same references relate to the same elements.

Before explaining the disclosed health data integration system and the method thereof, we describe some background of the invention. It is used in a network structure with clients and a server. The client is a computer executable platform with the network transmission capability, such as a personal computer (PC), personal digital assistant (PDA), and mobile phone. The client may even have a sensor for detecting the user's health data. For example, the sensor can detect the user's body mass index (BMI), exercising conditions, biological data, environmental data, or their combination. The server is a computer executable platform applying the present invention. It receives consulting messages and health data transmitted from the client and processes them. The processing detail will be described hereinafter.

Special terms used in this specification are defined as follows. The consulting message mentioned herein is a question raised by the user. (For example: according to my conditions, what would be the appropriate diet control?) The question can be represented in terms of text, icons (e.g., ultrasound icon), codes (e.g., the International Categories of Diseases (ICD) or current procedural terminology (CPT)), or their combination and transmitted to the network community. The health data refer to the body mass index (BMI), exercising conditions, biological data, environmental data, or their combination. As one example, the BMI is computed from the user's height and weight. The exercising conditions include counting of the pedometer. The biological data include heartbeats, blood pressure, and body temperature. The environmental data include temperature, pressure, and air quality. Besides, the health data may even include an identification (ID) code for identification. This can avoid the health data from being mixed up between different people.

The analysis conditions refer to the standard ranges of the health data. They are pre-stored in the health database of the present invention. Take the BMI as one example. Its analysis condition can be divided into fat (BMI≧25), overweight (23≦BMI≦24.9), and ideal (18.5≦BMI≦22.9). Finally, the health advice report is generated according to the health data and analysis conditions by the report generating module. It can use statistical charts (including graphs, tables, and text) in the presentation so that the user can clearly understand what to watch after (e.g., the BMI being over the standard range). For example, the chart can be a two-dimensional chart with x and y axes, where the x axis represents the time and the y axis represents the BMI value. The health data here would be a stacked line. Moreover, the medical standard range in the chart can be marked with a different color. In this way, the user can readily know the variation in his BMI value in a particular period and whether it falls in the standard range. It should be noted that the statistical chart may further include a note area for the user to put in text (e.g., names of drugs being taken).

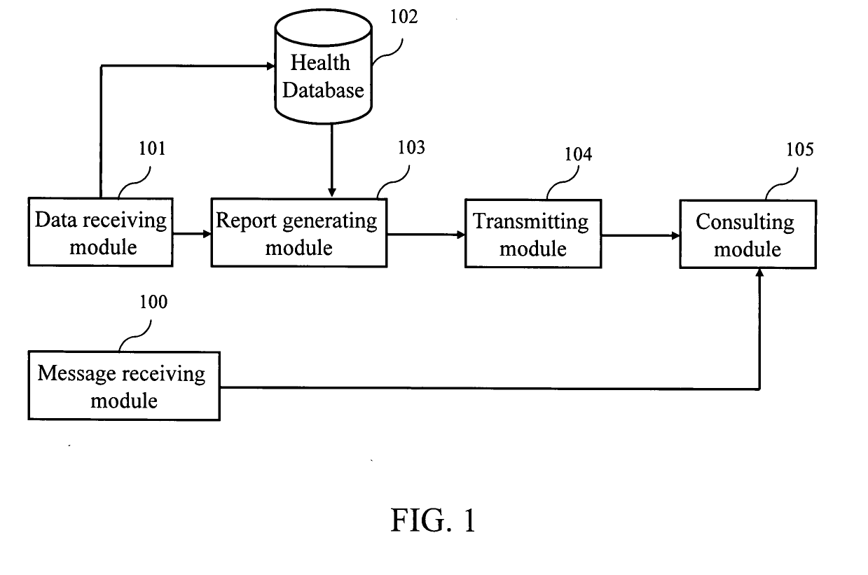

Before describing an embodiment of the present invention, we first explain the disclosed health data integration system and method with the accompanying figures. FIG. 1 is a block diagram of the disclosed health data integration system. It includes a message receiving module 100, a data receiving module 101, a health database 102, a report generating module 103, a transmitting module 104, and a consulting module 105.

The message receiving module 100 is used to receive a consulting message. The consulting message is the question from the user (e.g., what would be appropriate diet control for me according to my conditions?). Such a message can be represented using text, icons, codes, or their combination. The data receiving module 101 is used to receive health data transmitted from a client. The client may include a sensor for detecting health data (e.g., measuring steps using a pedometer or measuring the blood pressure using a blood pressure meter).

The health database 102 stores the health data received by the data receiving module 101 and the predetermined analysis conditions. The health data and analysis conditions have been described before and are not repeated here again. The report generating module 103 generates a health advice report according to the health data and the analysis conditions. For example, according to the measured BMI (e.g., 28) and the analysis conditions (e.g., fat when BMI≧25), a health advice report that reminds the user to watch his weight is generated. The health advice report can be presented in terms of statistical charts such as graphs, tables, and text, so that the user can readily understand his health conditions. For the current example, the health advice report can further provide a training procedure for reducing weight (e.g., an exercise schedule designed for reducing weight). The exercise procedure includes a planning of item, time, and place. It can even be adjusted according to the user's biological cycle (e.g., preventing tough exercises when the user is in a low mood). The transmitting module 104 transmits the health advice report generated by the report generating module 103 to the client via a network. The consulting module 105 transmits the consulting message and the health advice report to a network community. The network community can be a message board, a forum, a chat room, an electronic bulletin board, or their combination.

Besides, the system further includes an online diagnosing window that performs a diagnosis through the combination of images, voices, and text. For example, the user can have interactions with other people (medical professionals or network friends) via video conferencing or instant messengers, thereby gaining professional or nonprofessional advice.

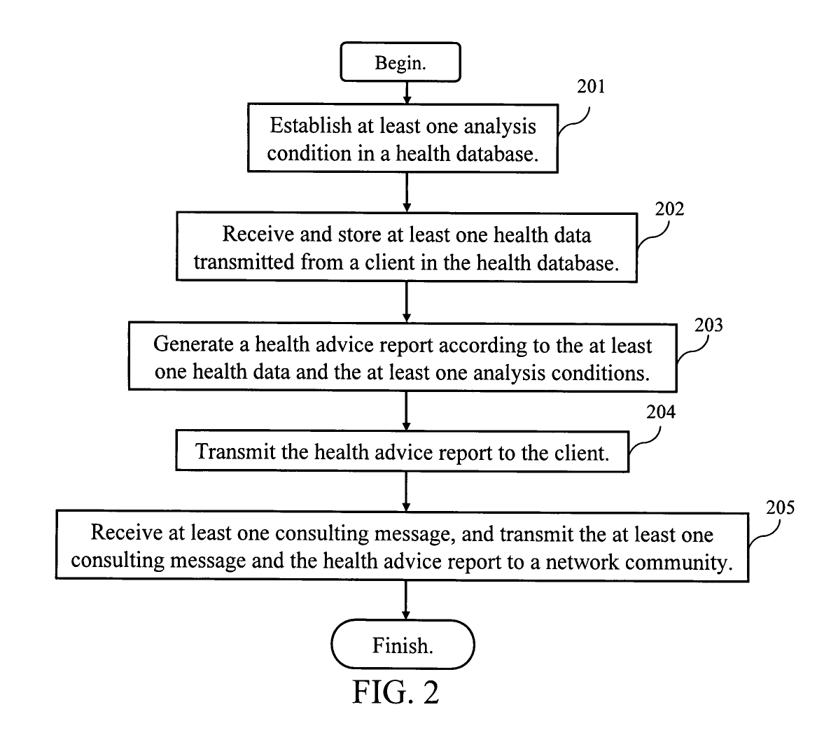

FIG. 2 shows the flowchart of the disclosed health data integration method. It includes the following steps. Step 201 establishes analysis conditions in a health database 102. Step 202 receives and stores health data transmitted from a client to the health database 102. Step 203 generates a health advice report according to the health data and the analysis conditions. Step 204 transmits the health advice report to the client. Step 205 receives a consulting message and transmits the consulting message and the health advice report to a network community. Moreover, the disclosed health data integration method further includes the step of performing a diagnosis through an online diagnosis window, using the combination of icons, voices, and text.

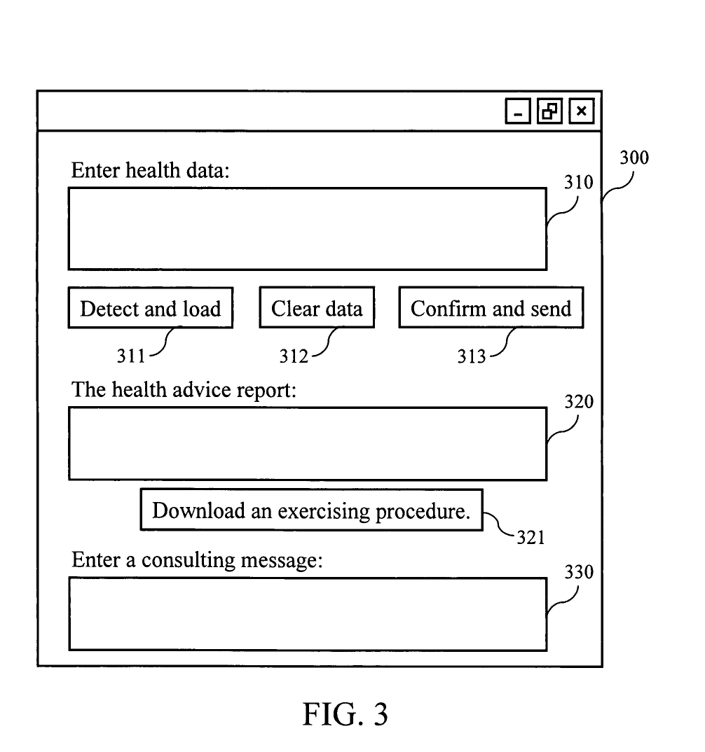

An embodiment is described below with reference to FIGS. 3 to 5. FIG. 3 is a schematic view showing the operation of entering the health data according to the invention. When the user obtains the number of steps (the health data) from a sensor (e.g., pedometer), he can enter the data in the health data input area 310 provided in the health data operating window 300 of a computer executable platform (e.g., a PC). The health data input area 310 allows the input of BMI, exercising conditions, biological data, environmental data, or their combination. For example, if the number of steps showing on the pedometer is 5000, the input value of the step field in the health data input area 310 is 5000 (not shown).

Furthermore, if the pedometer has the transmission function with a computer executable platform, one can even click a detecting and loading element 311 to detect and load the number of steps recorded by the pedometer (e.g., 5000) for better input efficiency. Afterwards, if there is an error in the input health data, the incorrect data can be erased by clicking a data clearing element 312 until all health data are correct. Finally, by clicking a confirming and sending element 313, the health data are transmitted. It should be noted that the health data may further include an ID code to prevent the health data from being mixed up between different people. The elements in the above-mentioned health data operating window 300 are not restricted to the example given here.

After the data receiving module 101 receives the health data transmitted from the client (e.g., the number of steps is 5000), the health data are stored in the health database 102. The storage method can be in accord with the ID code in the health data or the identification message (e.g., the login account) of the client. The report generating module 103 generates a health advice report (e.g., showing that the current number of steps of the user is 5000, the standard number of steps is 10000, and the user is suggested to walk more) according to the health data and the analysis conditions (e.g., the standard number of steps for each person each day is 10000) pre-stored in the health database 102. The health advice report may further include a scheduled exercise procedure (e.g., the contents are: “wake up at 6:00 AM and walk 2500 steps in the track field; walk another 2500 steps in the track field at 8:00 PM”). Afterwards, the transmitting module 104 transmits the health advice report to the client. After the user receives the health advice report via the client, he can consult by entering a question in the consulting message input area 330. Besides, the health advice report can be first displayed in an advice report display area 320. An exercise procedure downloading element 321 is provided for the user to click and download the exercise procedure in the health advice report.

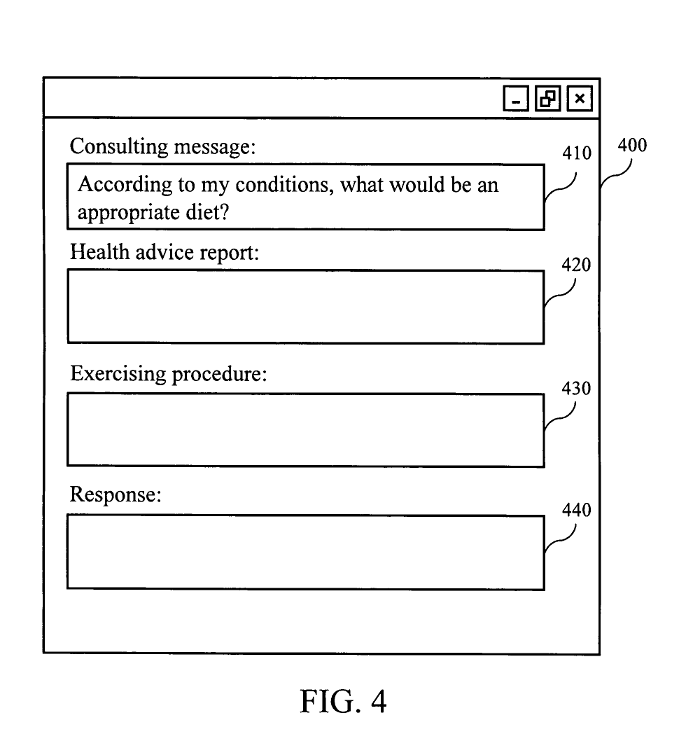

FIG. 4 is a schematic view of health consulting according to the invention. As mentioned before, after the client receives the health advice report transmitted by the transmitting module 104, the user can consult by entering his question (consulting message) in the consulting message input area 330 at the client. Therefore, after the user enters the consulting message, the message receiving module 100 receives the consulting message entered by the client. Through the consulting module 105, the consulting message and the health advice report are transmitted to the network community. The health consulting can be displayed in a way as the consulting display window 400 in FIG. 4. Its consulting message display area 410 shows the consulting message (e.g., which would be appropriate diet control for me according to my conditions?). Its health advice report display area 420 and exercise procedure display area 430 displays the health advice report and the exercise procedure therein produced previously according to the health data of the user. Besides, when there is any response to the consulting message, it is displayed in the consulting response display area 440. More explicitly, the invention does not have any restriction on the operational method and display scheme for health consulting. In practice, it can be done through a message board, forum, chat room, or electronic bulletin board system. That is, the consulting message and the health advice report are transmitted to the network community for other users (e.g., medical professionals, fitness coach or users in a similar situation) to make appropriate responses to the consulting message according to the health advice report. This achieves the goal of health consulting.

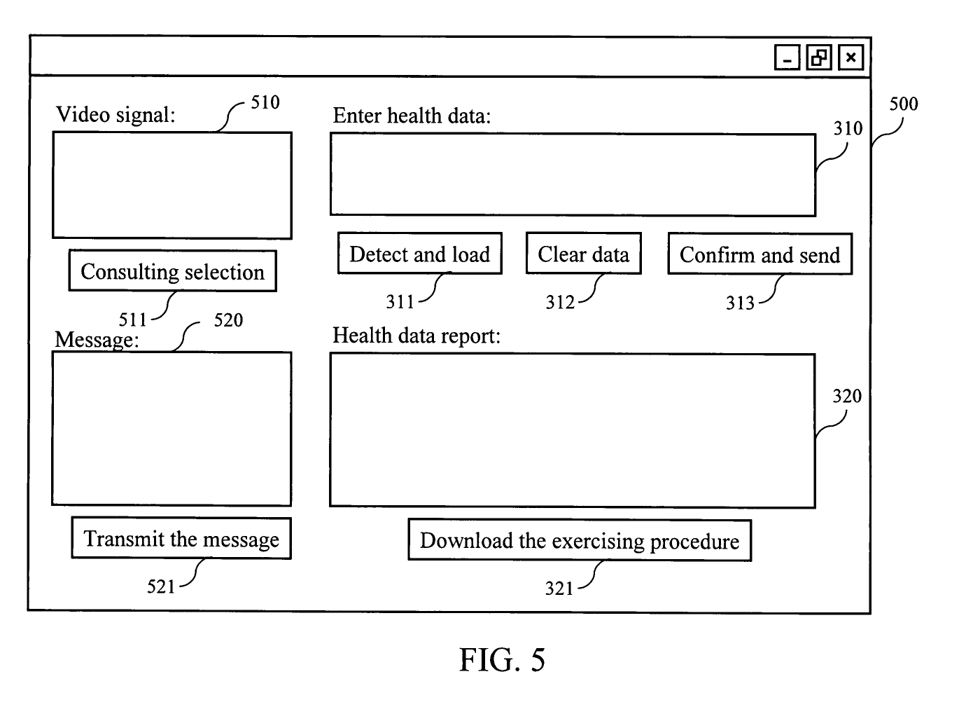

FIG. 5 is a schematic operation diagram showing the disclosed online diagnosis. In addition to obtaining the health advice report and consulting, the user can further perform an online diagnosis through the online diagnosis window 500. The procedure of entering the health data to obtaining the health advice report has been described above. It is thus not repeated herein again. The following paragraph explains the part of online diagnosis.

After the user receives the health advice report, he can click a consulting selection element 511 to get online diagnosis if he has any question in the report. Particularly after the user selects a consultant (not shown), his image (e.g., video image) can be further displayed in the image display area 510 and the consulting is performed in voices. Moreover, after entering words in a message input area 520, the user can click a message transmitting element 521 to send out the input words. The elements contained in the online diagnosis window 500 are not restricted to those described in this example.

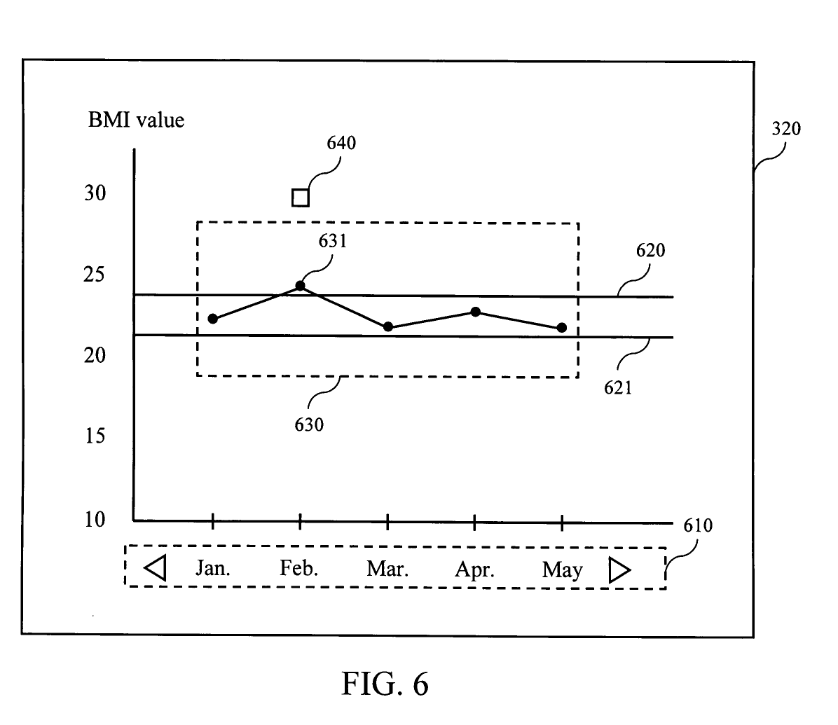

Finally, FIG. 6 is a schematic view of the statistical chart according to the invention. As mentioned before, the health advice report (e.g., the health advice report for the BMI value) can be represented using a statistical chart (e.g., a stacked line figure). As shown in FIG. 6, the health advice report is a two-dimensional plot with an x axis (representing time, for example) and a y axis (representing the BMI value, for example). It is displayed in the advice report displaying area 320. In particular, the range of the x axis can be determined using a time control axis 610 (e.g., between January and May). The y axis shows the marks of BMI values. The standard upper limit 620 and lower limit 621 show the medical standard range of the BMI value. Take this case as one example, a stacked line of the BMI value 630 shows its variation in time. The standard range can be labeled with a color (e.g., green) for the user to clearly identify. It should be noted that when the BMI value 631 exceeds the standard range within the time range of the x axis, the note area 640 is displayed for the user to click and generate a floating input frame (not shown), thereby entering and record a text explanation (e.g., watch the diet!).

In summary, the difference between the invention and the prior art is in that the health advice report is generated for health consulting after detected health data are transmitted via a network to the server for recording and analysis. This technique enables the user to conveniently record his health data and obtain the health advice report. Not only does the invention solve problems existing in the prior art, it further facilitates health data recording and applications.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A health data integration system, comprising:
a message receiving module, which receives at least one consulting message;
a data receiving module, which receives at least one health data transmitted from a client;
a health database, which stores the at least one health data and at least one analysis condition;
a report generating module, which generates a health advice report according to the at least one health data and the at least one analysis condition;
a transmitting module, which transmits the health advice report to the client; and
a consulting module, which transmits the at least one consulting message and the health advice report to a network community.

2. The health data integration system of claim 1, wherein the client includes at least one sensor for measuring the at least one health data.

3. The health data integration system of claim 2, wherein the at least one health data include the body mass index (BMI), exercising conditions, biological data, environmental data, or their combination.

4. The health data integration system of claim 3, wherein the at least one health data further includes an identification code for identification.

5. The health data integration system of claim 3, wherein the at least one analysis conditions are the medical standard ranges of the at least one health data.

6. The health data integration system of claim 1, wherein the health advice report is a statistical chart displayed in terms of graphs, tables, text, or their combination.

7. The health data integration system of claim 6, wherein the statistical chart includes at least one note area for recording text.

8. The health data integration system of claim 1, wherein the at least one consulting message is text, image, code, or their combination.

9. The health data integration system of claim 1, wherein the network community is a message board, a forum, a chat room, an electronic bulletin board system, or their combination.

10. The health data integration system of claim 1, wherein the system further includes an online diagnosis window for performing a diagnosis via images, voices, text, or their combination.

11. A health data integration method, comprising the steps of:
establishing at least one analysis condition in a health database;
receiving and storing at least one health data transmitted from a client to the health database;
generating a health advice report according to the at least one health data and the at least one analysis conditions;
transmitting the health advice report to the client; and
receiving at least one consulting message and transmitting the at least one consulting message and the health advice report to a network community.
